(19) United States
(12) Patent Application Publication
(10) Pub. No.: US 2016/0276114 A1
(43) Pub. Date: Sep. 22, 2016

(54) Remote Tripping Device

(71) Applicants: William D. Reed, SR., Waterloo, IL (US); Christine Noethem Reed, Waterloo, IL (US)

(72) Inventors: William D. Reed, SR., Waterloo, IL (US); Christine Noethem Reed, Waterloo, IL (US)

(21) Appl. No.: 14/658,814

(22) Filed: Mar. 16, 2015

(51) Int. Cl. H01H 9/54

(52) U.S. Cl. CPC H01H 9/54

(57) ABSTRACT

The invention relates to a tripping device with a short-circuit current sensing polarity indicator for sensing an instantaneous current and an instantaneous voltage in each standard receptacle. A tripping device includes at least one plug; at least one push button; at least one power indicator; at least one polarity indicator; and one or more voltage source.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

1. Field of the Invention

This invention relates to tripping devices for circuit breakers. Specifically, this invention is an electronic over a current tripping device with a short circuit detector, or shunt trip, which is used in the circuit-breakers of electrical equipment.

2. Background of the Invention

In most circuit-breakers, voltage emissions, or shunt trips, are used to open the circuit-breaker from a distance by means of a control device.

There are also circuit-protective apparatuses in circuit-breakers that interrupt a circuit with quick-make and quick break contacts. These are triggered by thermal tripping devices that are comprised of a bimetallic element. The breaker automatically trips when either an overload or short circuit occurs, and is kept open until the current returns to normal. These circuit-breakers have relay means, or a solenoid, that have an operating coil. The main contact point between the supply circuit and the equipment being protected is linked to the interrupter.

The automatic tripping is usually accomplished by a series over current tripping device which may be a thermal tripping device, such as a bimetallic element, or may constitute the operating coil of the solenoid which is connected in series with the circuit in which the breaker is installed. Overloads of long duration are interrupted by these breakers which have time delay elements therein before damage is done. Short circuits are interrupted by instantaneous elements so that selective tripping systems are possible, which include long-time delay and short-time delay elements to trip at different times. Many of these now circuit breakers are limited in that they are manually operated.

In addition to, or as an alternative to the above-described safety devices, so-called current-limiting devices can also be used. These devices exist in various forms, and make the circuit breaker's contacts separate when a short-circuit occurs, regardless of any action being taken by the other safety devices installed.

The most common type of tripping device is based on a special configuration between the contacts and the related electrodes designed to ensure the spontaneous repulsion of the moving contact away from the fixed contact. This is achieved due to electrodynamics forces that develop in the event of a short-circuit. These forces are known to act in the opposite direction to the forces exerted by the contact springs when an automatic circuit breaker is in the closed position. The forces of repulsion depend on the intensity of the current and, in rated current conditions, they must be kept considerably lower than the forces exerted by the contact springs in order to guarantee the circuit-breaker an optimal conductivity. The known devices are designed only for the event of short-circuit currents of a given value that electrodynamics repulsion forces can overcome the forces exerted by the contact springs and thus induce the separation of the moving contacts from the fixed contacts.

After the contacts have separated due electrodynamics repulsion, there must be other devices to prevent the moving contacts from returning to the fixed contacts, i.e. to prevent the risk of arc re-ignition, as well as other devices to provide a suitable signal outside the switching device to indicate the separated state of the contacts, or “device tripped.” This dual purpose is normally achieved by fitting the limiting devices with sensors that can detect the separation of the contacts and subsequently trip the release device, irrespective of any action being taken by the safety device. The application of such devices is very complicated, and reinstallation of such devices after short-circuit is very expensive.

The electromechanical indicators presently available have limitations. They are typically heavy, and consume a great deal of power, even the miniaturized versions. Also, the moving parts of an electromechanical device may be susceptible to reliability problems.

In addition, commonly known tripping devices disclose a fault indicator for electrical devices. It is based on liquid crystals, whose alignment can be affected by an electric or magnetic field, causing the visual appearance of the indicator to change. While such indicators are suitable for a large variety of applications, they do have certain limitations. Their switching voltage is relatively high, typically about 80 volts. The alignment of the liquid crystals therein can be randomized by high temperatures, causing an indicating state to be “erased” by accidental exposure to high temperatures, creating the risk of erroneous readings.

The present invention provides a lightweight, low-power consuming, re-stable, and reliable state indicator, and tripping devices with polarity indicator.

### SUMMARY OF THE INVENTION

The primary objective of the invention is to locate a circuit-break and repair the circuit without damaging the receptacle.

Another objective of the invention is to improve the over current tripping device, described in the above-mentioned background, in such a manner that short-circuits is detected and a circuit-breaker is tripped in response.

This invention also provides a device having a state indicator, comprising a component whose operating state is to be indicated, a state indicator such as described hereinabove, and a sensing means for sensing a predetermined change in the operating state of the component and sending in response to such change a signal to the tripping means of the indicator.

Another objective of the present invention is to provide an automatic circuit-breaker that requires no complicated and costly maintenance operations to guarantee a perfect functionality of the contact tripping operation.

Another objective of the present invention is to provide a compact and accurate tripping device that does not use batteries.

Another object of the present invention is a tripping device working in 120 volt wiring.

Another object of the present invention is a tripping device with a limited number of components that are easy to assemble.

The automatic tripping device, according to the present invention, enables the moving contact to be exploited directly, not only for its principal function, but also to actuate the kinematic tripping system and the consequent command mechanism. This eliminates the need to use additional devices or transducers, such as the pressure sensors or electromagnetic sensors normally used for said purpose. Moreover, a substantial mechanical kinematic tripping system enables a rapid and precise circuit breaker response.

These together with other objects of the invention, along with the various features of novelty which characterize the invention, are pointed out with particularity in the disclosure. For a better understanding of the invention, its operating advantages, and the specific object attained by its uses, reference should be made to the accompanying drawings and descriptive matter, in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts a schematic view of a tripping device according to the invention in the closed position;

FIG. 2 depicts a schematic view of the circuit diagram of the embodiment of the present invention.

FIG. 3 depicts a schematic drawing illustrating the electrical connections of the components of the present invention illustrated in FIG. 2.

### DETAILED DESCRIPTION OF THE INVENTION

In the following detailed description, reference is made to the accompanying drawings which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended claims and their equivalents.

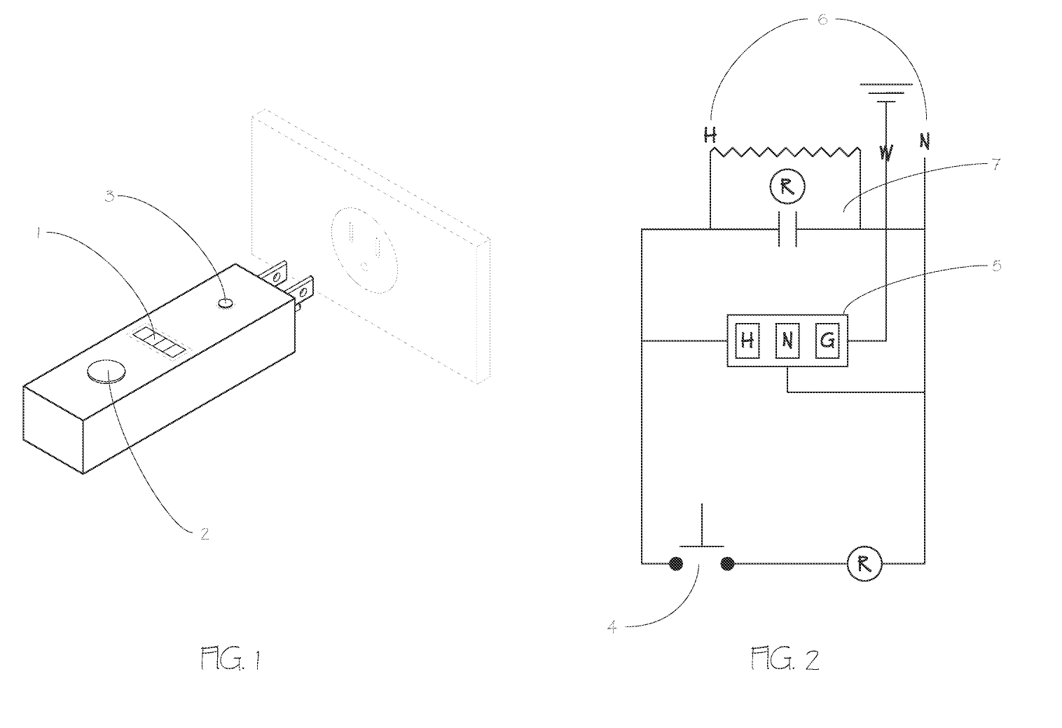

According to FIG. 1, a broad aspect of the invention is providing a tripping device with a short-circuit current sensing polarity indicator 1. The trip device of the present invention is compact and rectangular in shape, with the plastic exposure having a 125 AC grounded plug on its end. On its face a compact pin push button 2 is attached so that when depressed, it would short out the circuit, causing the breaker to trip it. It has a power indicator, as well as a polarity indicator light 3.

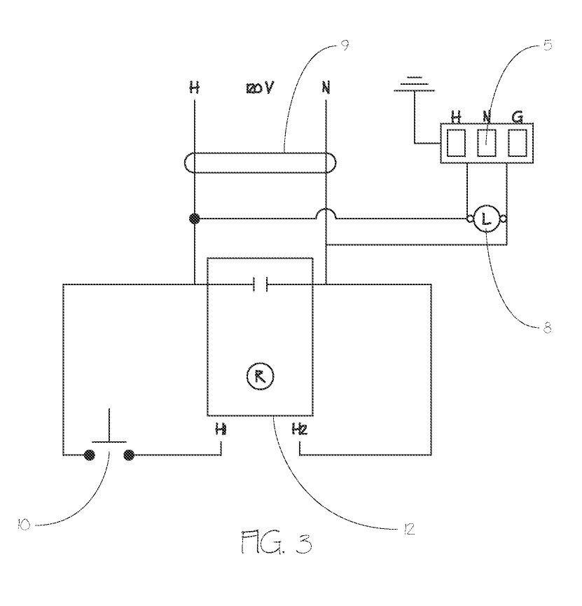

FIG. 2 shows a circuit diagram of the invention: a push pin momentary contact 4 is normally open, woodhead polarity receptacle 5, a receptacle with hot neutral and ground positions 6 could be a plug in, and relay contacts 7.

FIG. 3 demonstrates the electrical collection of the invention with the system with woodhead polarity receptacle 5, a lamp indicating 120 volt to nothing 8, hot wire and neutral wire 9, a push button switch 10, and relay rated for short circuit 11 able to handle the ampacity.

When an overload or short-circuit occurs and exceeds a certain value, this device is plugged into a standard receptacle, and by pushing the short button a momentary contact is made with the power wire, and the constant wire trips the circuit. The voltage sensor will then show no circuit voltage, and the circuit breaker in the box will remain tripped. This device consumes no power and produces information on the circuit. It can remotely trip the circuit breaker, which makes the workplace safer.

When the overload or short-circuit is repaired, and current is within the prescribed limit, the tripping device restores itself to its rest position, allowing the control contact to restore itself to its rest position. It is understood that the control contact is normally in this rest position, and is biased to its rest position.

Those skilled in the art will appreciate that the polarity indicator for sensing a change in the operating state and transmitting a signal in response thereto can be constructed in any number of ways. NO shows schematically a simple circuit diagram comprising of a switch and voltage source, in combination with a polarity indicator of this invention. The switch is responsive to the operating state of the device or component being monitored. It is set to remain open so long as a predetermined change in operating state does not occur. For example, the switch may be sensitive to temperature, vibration, voltage, etc. When the predetermined change in operating state occurs, the switch closes, thereby closing the electrical circuit between the voltage source and the detector. Without the damage of the receptacle of the trip, it can remotely trip and locate a circuit breaker using the power in the circuit. The trip is light and accurate, and can operate without batteries.

It is to be understood that the above description is intended to be illustrative, and not restrictive. For example, the above-discussed embodiments may be used in combination with each other. Many other embodiments will be apparent to those of skill in the art upon reviewing the above description.

We claim:

1. A tripping device with a short-circuit current sensing polarity indicator comprising:
means for sensing an instantaneous current and an instantaneous voltage in each standard receptacle;
means of at least one plug;
means of at least one push button;
at least one power indicator;
at least one polarity indicator; and one or more voltage source.

2. The tripping device with a short-circuit current sensing polarity indicator of claim 1, wherein said plug is present on the end of said tripping device.

3. The tripping device with a short-circuit current sensing polarity indicator of claim 1, wherein said push button when depressed would short out the circuit causing breaker of trip it.

4. The tripping device with a short circuit current sensing polarity indicator of claim 1, wherein said voltage source is available in combination with a said polarity indicator.

5. The tripping device with a short circuit current sensing polarity indicator of claim 1, wherein said power indicator is available in the combination with said voltage supply.

6. The tripping device with a short circuit current sensing polarity indicator of claim 1, wherein said device is working with said standard receptacle with 120 volt wiring.

7. The tripping device with a short circuit current sensing polarity indicator of claim 1, wherein said polarity indicator will be light indicating.

8. The tripping device with a short circuit current sensing polarity indicator of claim 1, wherein said device is compact and rectangular in shape.

9. The tripping device with a short circuit current sensing polarity indicator of claim 1, wherein said device is light in weight, accurate and can operate without batteries.

10. A method of tripping with a short-circuit current sensing polarity indicator comprising:
providing a short circuit when overloading occurs or exceeds a certain value, the said device is plugged into a said standard receptacle and by pushing the short button a monetary contact is made with the said power wire, and the constant wire trips the circuit. The voltage sensor will then show no circuit voltage, and the circuit breaker in the box will remain tripped;

11. The said method of claim 10 involve a switch, a voltage source in combination of polarity indicator;
providing the predetermined change in the operative state, wherein switch closes thereby closes the said electrical circuit between the said voltage source and the said detector.

12. The said method of claim 10 involve restoring of tripping device, wherein said restore state attain when the current is come in the prescribe limit.
